(19) United States
(12) Patent Application Publication
(10) Pub. No.: US 2008/0259920 A1
(43) Pub. Date: Oct. 23, 2008

(54) Method and apparatus for establishing virtual resilient packet ring (RPR) subrings over a common communications path

(75) Inventors: Weiying Cheng, Naperville, IL (US); Chris R. Zettinger, Wheaton, IL (US); Michael T. Moran, Sandwich, IL (US); Gilbert A. Buescher, Naperville, IL (US); Kimberly A. Stoddard, Crystal Lake, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc.

(21) Appl. No.: 11/787,756

(22) Filed: Apr. 17, 2007

(51) Int. Cl. H04L 12/56

(52) U.S. Cl. 370/390; 370/403

(57) ABSTRACT

A method and corresponding apparatus allows multiple virtual switches in a physical switch to share one physical Resilient Packet Ring (RPR) in an RPR network. Modules in the multiple virtual switches add multicast information to traffic to direct the traffic along a common path to other physical switches on the ring, and modules in the virtual switches inspect traffic to determine whether the traffic is directed to the respective virtual switch. Multiple virtual RPR subrings are made available in a single physical ring, increasing usefulness of virtual switches formerly only able to support multiple tributary connections to other networks but not able to share a single ring network communications path. Sharing a single communications path increases overall network bandwidth, and at least one implementation allows for spatial reuse.

### BACKGROUND OF THE INVENTION

A switch may be logically partitioned into a number of virtual switches, each functioning as an independent switch. Such partitioning of a physical switch may be done for the purpose of segregating traffic, much like a partitioned server where one physical server runs multiple virtual machines. For example, virtual switches may be created within physical switches of a ring network to separate different client networks that may be connected to the physical switches; however, each virtual switch requires its own link to another node on the ring network. Therefore, any advantages of the multiple virtual switches on the ring are either lost due to the virtual switches requiring multiple physical links for forming rings, or due to the virtual switches having to wait for access to a single ring.

### SUMMARY OF THE INVENTION

According to one example embodiment of the present invention, a ring network may have multiple physical switches configured with multiple virtual switches with access to a common path on the ring network. The multiple virtual switches may include modules that add multicast information to traffic to direct the traffic along the common path to at least one other physical switch on the ring network.

In another example embodiment, a physical switch configured with multiple virtual switches may include at least one module to add multicast information to traffic to cause at least two of the multiple virtual switches to direct the traffic to a common path to at least one other physical switch, and may include at least one module to inspect multicast information in traffic received from a path from other virtual switches in another physical switch to direct the traffic to a destination associated with at least one of the multiple virtual switches.

In yet another example embodiment, a traffic signal may be embodied in a carrier wave supporting communications in a ring network, and may include overhead bits with multicast information and at least one bit defining the traffic to be “flood” traffic.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating a Resilient Packet Ring (RPR) network having four physical switches.

FIG. 2 is a network diagram illustrating an RPR network having four physical switches, each configured with three virtual switches.

FIG. 3 is a detailed block diagram illustrating a physical switch in an RPR network configured with three virtual switches.

FIG. 4 is a header diagram illustrating example tunnel and virtual ring labels that are added to traffic to be transmitted over virtual RPR subrings (VRPR-S).

FIGS. 5A and 5B are flow diagrams illustrating adding information to traffic to be transmitted over virtual RPR subrings (VRPR-S).

FIGS. 6A and 6B are flow diagrams illustrating handling network traffic received from virtual RPR subrings (VRPR-S).

### DETAILED DESCRIPTION OF THE INVENTION

A description of example embodiments of the invention follows.

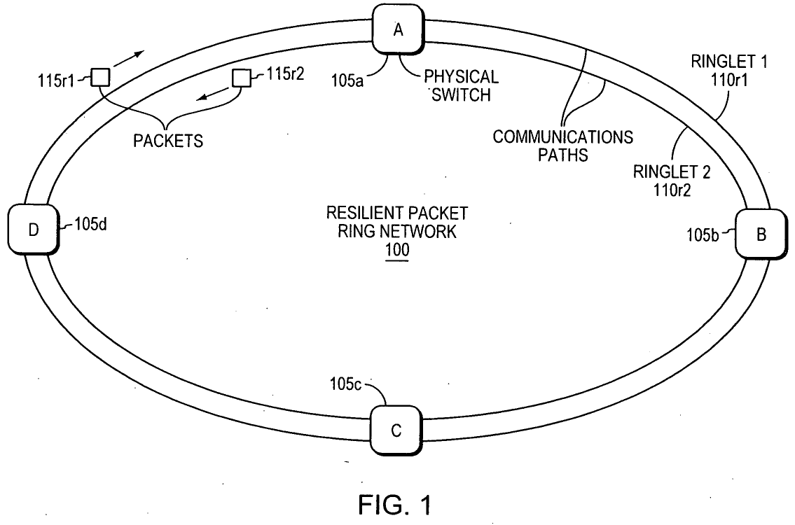

FIG. 1 is a network diagram of a Resilient Packet Ring (RPR) network (“RPR ring”) 100, also referred to herein simply as a “ring.” The ring 100 has four physical switches 105a-d coupled by two counter-rotating communications paths in this example, Ringlet 1 110r1 and Ringlet 2 110r2. Traffic 115r1 on Ringlet 1 110r1 travels clockwise around the ringlet 110r1, and traffic 115r2 on Ringlet 2 110r2 travels counterclockwise around the ringlet 110r2. The terms “traffic” and “communications” are synonymous as used herein. The term “traffic” can be packets or frames, which are also synonymous as used herein.

Resilient Packet Ring (RPR) in noun form refers to a ring-based network protocol that supports bridging to other network protocols, such as Ethernet. Today's RPR uses 48-bit source and destination Media Access Control (MAC) addresses in the same format as Ethernet. When an Ethernet frame is bridged onto an RPR ring, an RPR station on the ring encapsulates the Ethernet frame with an RPR header in an RPR frame. Likewise, when a station copies an RPR frame from the ring, the station removes the RPR header from the RPR frame in the Ethernet traffic.

To transmit a frame from one RPR station to another on the RPR ring, RPR processing in the RPR station encapsulates the frame with an RPR header and adds the newly formed RPR frame to the ring. A station may flood the RPR frame to all other stations on the ring by setting information in the RPR header to indicate that the frame is to be flooded. While the RPR frame traverses the ring, it encounters other RPR stations.

At a given station, the destination MAC address of the RPR header is examined. If the destination address of the frame's RPR header is the same as the station's address and the frame is not indicated as being flooded, then the frame is copied without being forwarded to the next station on the ring. On the other hand, if the destination address of the RPR header is different than the station's address and the frame is not indicated as being flooded, then the frame is forwarded to the next station on the ring. However, if the frame is indicated as being flooded, then the frame is copied before being forwarded to the next station on the ring. To prevent a flooded frame from endlessly traveling around the ring, the station will also examine the source address of the RPR header. If the source address is the same as the station's address, then the frame will be dropped, thus, preventing an infinite loop.

When an RPR station receives a non-flooded RPR frame and recognizes the destination address, it removes the RPR frame completely from the ring, unlike in the case of flooded frames, that simply copy the contents of the frame and let the frame traverse the rest of the ring. When the receiving station removes the RPR frame from the ring, the bandwidth otherwise consumed by the RPR frame is available for use by other RPR stations. This is known as spatial reuse. It should be noted that an RPR station may implement spatial reuse if the destination of the frame is one of the RPR stations, otherwise, the station must flood the frame on the ring.

Current RPR technology allows each RPR physical port to be associated with only one virtual switch instance within a physical switch, which limits the number of subscribers that can access an RPR ring if virtual switches are used to separate subscribers.

Today's Virtual Local Area Networks (VLAN) allow multiple subscribers to access an RPR ring, but do not allow multiple virtual switches to access an RPR ring. Moreover, a limited number (e.g., 4096) of VLANs can be supported on a ring due to space limitations of VLAN identifiers in header information of traffic packets if an RPR physical port can be associated with only one virtual switch within a physical switch.

Unicast tunnels over an RPR ring can be used to allow multiple virtual switches to share an RPR ring with spatial reuse, but the approach requires Label Switched Path (LSP) configuration. Moreover, it does not support multicast traffic.

The use of an RPR ring over Virtual Concatenation (VCAT) allows for the use of multiple RPR rings, as the bandwidth in VCAT is divided into smaller circuits that act as independent circuits, but the bandwidth for each ring is fixed. This approach is inadequate as the provisioning and implementation of RPR rings over VCAT is overly complicated and wastes bandwidth.

The present method and apparatus allows multiple virtual switches in a physical switch to share one physical Resilient Packet Ring (RPR) without using LSP provisioning. According to an example present method, an RPR ring is partitioned into a set of logical entities to allow multiple virtual switching instances within a physical switch to access the physical RPR ring over a wavelength. These logical entities may be envisioned as virtual RPR subrings. Each virtual RPR subring behaves the same as an RPR ring as defined by IEEE 802.17, and can support many (e.g., 4096) Virtual LANs (VLANs). The entire ring, therefore, may support as many (e.g., 4096)×N VLANs, where N is the number of virtual RPR subrings. The virtual RPR subrings have flexible bandwidth allocation and may co-exist with unicast LSP tunnels, or Layer 2 bridging traffic over the RPR ring.

In one method for providing such virtual RPR subrings, multicast information is added by a virtual switch to traffic to be communicated between a group of virtual switches in different physical switches on a ring network. The traffic is then forwarded to a path between the different physical switches on the ring network already carrying other traffic between other virtual switches that are also in the different physical switches. It should be noted that the path between the different physical switches may carry traffic from all of the virtual switches on the ring network, and that a virtual RPR subring is part of the path, connecting virtual switches belonging to the same group. Only traffic traveling between the virtual switches in the group may travel over the virtual RPR subring. Traffic traveling between different virtual switches belonging to different groups travel over different virtual RPR subrings.

Upon receiving traffic at a given physical switch from an RPR subring, the traffic is provided to multiple virtual switches within the physical switch. The traffic is then forwarded to a destination associated with at least one of the virtual switches if the traffic includes virtual switch information corresponding to a virtual switch identifier of the virtual switch.

The multicast information in the traffic may include a virtual ring label to identify a virtual ring connecting virtual switches belonging to the same group and a tunnel label to instruct the RPR station to flood the frame (e.g., setting a flood indication to “true”). The virtual ring label may include virtual switch information corresponding to a virtual switch identifier shared by at least two virtual switches in different physical switches. It should be noted that all virtual switches belonging to the same group have the same virtual switch identifier, which may act as the identifier of the virtual ring that connects the virtual switches of the group.

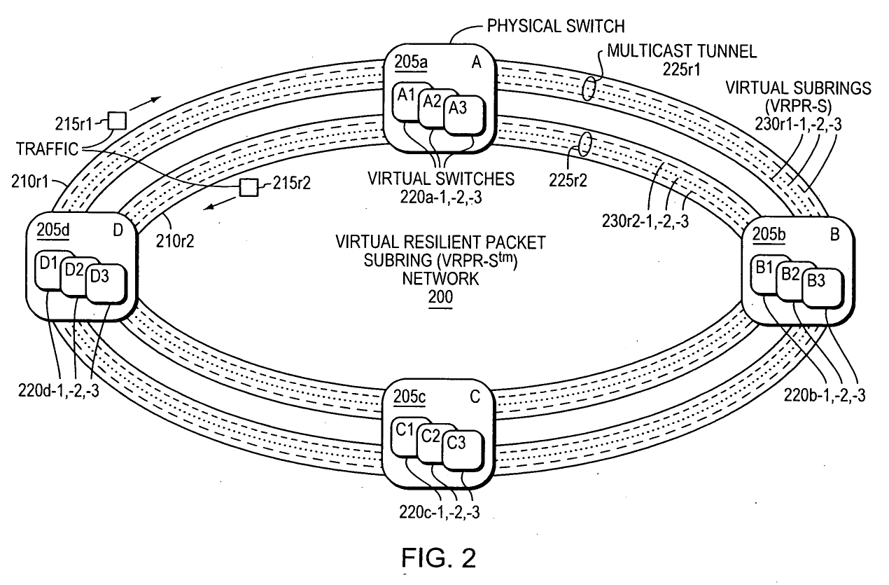

FIG. 2 is a network diagram that illustrates an RPR network 200 with an example embodiment of the present invention. The ring network 200 has four physical switches 205a-d coupled by two counter-rotating communications paths 210r1, 210r2. Each physical switch 205a-d is configured with three virtual switches 220a-1,2,3, 220b-1,2,3, 220c-1,2,3, and 220d-1,2,3, and each communications path 210r1, 210r2 is logically separated into three virtual subrings 230r1-1,2,3, 230r2-1,2,3 corresponding to the virtual switches.

In the illustrated ring network 200, a given virtual subring 230r1-1,2,3, 230r2-1,2,3 carries traffic 215r1, 215r2 between virtual switches within the same group but at different locations on the ring network. For example, traffic 215r1, 215r2 coming into virtual switch A1 220a-1 on physical switch A 205a is sent to virtual switches B1 220b-1, C1 220c-1, and D1 220d-1 in physical switches B 205b, C 205c, and D 205d, respectively, via subring 230r1-1. This is the case because virtual switches A1 220a-1, B1 220b-1, C1 220c-1, and D1 220d-1 share the same virtual switch identifier and, therefore, share the same virtual subring 230r1-1. Likewise, virtual switches A2 220a-2, B2 220b-2, C2 220c-2, and D2 220d-2 share virtual subring 230r1-2, and virtual switches A3 220a-3, B3 220b-3, C3 220c-3, and D3 220d-3 share virtual subring 230r1-3.

The virtual subrings 230r1-1,2,3, 230r2-1,2,3 are separated using virtual ring identifiers, and traffic packets traveling over the virtual subrings are transmitted through a multicast tunnel (not shown). For each virtual subring, a tunnel label is used to designate the traffic as being multicast traffic, and a virtual ring label is used to indicate that the multicast traffic is to be shared by virtual switches with matching virtual switch identifiers. In the illustrated example, the matching virtual switch identifiers of the virtual switches on a given virtual subring is used as the virtual ring label.

The virtual RPR subring (VRPR-S) port is established by allocating a physical RPR port (not shown) to a virtual switch with a specified bandwidth. Bandwidth may be allocated to each virtual RPR subring according to the methods defined in IEEE 802.17, and the total bandwidth allocated to the virtual RPR subrings may not exceed the bandwidth of the physical RPR ring. In some embodiments, bandwidth allocation is uniform; that is, the total bandwidth for traffic added at all the virtual switches on a given virtual RPR subring does not exceed the total bandwidth for the virtual RPR subring. Further, in some embodiments, bandwidth allocation is made in a spatially aware manner; that is, each span of the virtual RPR subring between a pair of virtual switches on the subring does not exceed the total bandwidth for the virtual RPR subring.

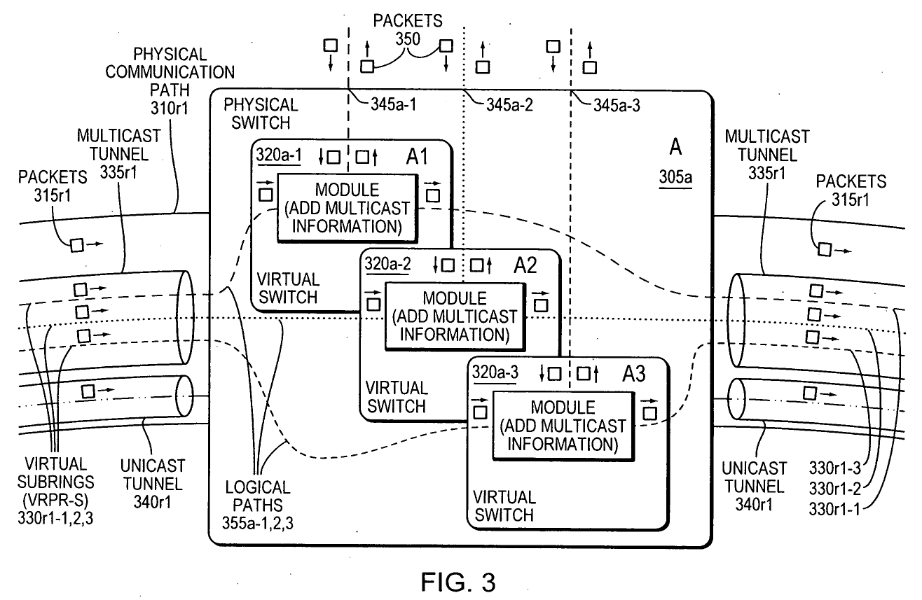

FIG. 3 is a block diagram that illustrates a physical switch 305a configured with three virtual switches 320a-1, 320a-2, 320a-3 according to an embodiment of the present invention. For the sake of simplicity, only one of the dual counter-rotating rings is shown. Packets 350 coming into the physical switch 305a on physical port 345a-1 are handled by a virtual switch A1 320a-1. A module 325a-1 in the virtual switch A1 320a-1 adds multicast information to the traffic to add the traffic to the corresponding virtual subring 330r1-l. Likewise, packets 350 coming into the physical switch 305a on other physical ports 345a-2 and 345a-3 are handled by other virtual switches A2 320a-2 and A3 320a-3, respectively. Modules 325a-2 and 325a-3 in virtual switches A2 320a-2 and A3 320-a-3 add multicast information to the traffic in order to add the traffic to the corresponding virtual subrings 330r1-2, 330r1-3. It should be noted that paths 355a-1, 355a-2, and 355a-3 through the physical switch 305a are logical paths and may travel over the same physical path within the physical switch 305a.

Traffic from the virtual switches 320a-1, 320a-2, 320a-3 are added to the same physical communications path 310r1. This traffic is divided into multiple virtual subrings 330r1-1, 330r1-2, 330r1-3 corresponding to the virtual switches 320a-1, 320a-2, 320a-3. All of the virtual subrings 330r1-1, 330r1-2, 330r1-3 traveling on the physical communications path 310r1 travel through a multicast tunnel 335r1. It should be noted that other traffic, such as a unicast tunnel 340r1, may also exist on the physical communications path 310r1.

Traffic coming into the physical switch 305a from the multicast tunnel 335r1 on the physical communications path 310r1 is inspected by the virtual switches 320a-1, 320a-2, 320a-3. Traffic traveling on virtual subring 330r1-1 is copied at virtual switch A1 320a-1 and sent out of the physical switch 305a on a corresponding physical port 345a-1. Likewise, traffic traveling on virtual subrings 330r1-2 and 330r1-3 are copied at virtual switches A2 320a-2 and A3 320a-3, respectively, and sent out of the physical switch 305a on corresponding physical ports 345a-2 and 345a-3.

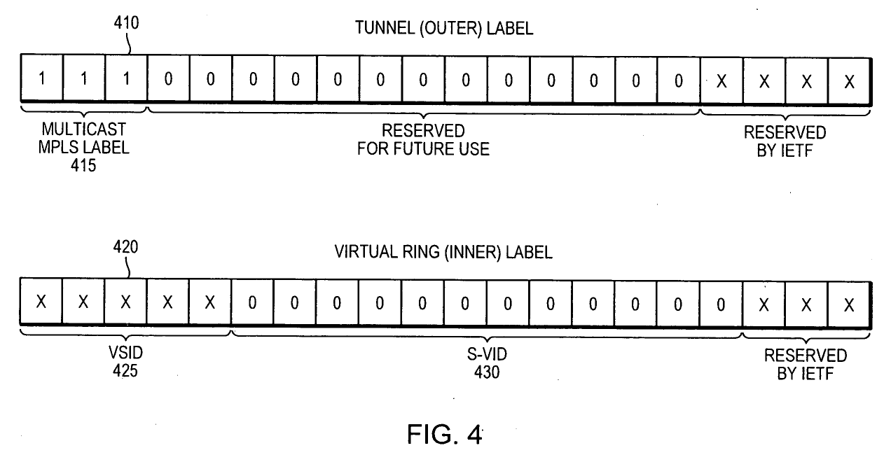

FIG. 4 is a header diagram illustrating example multicast tunnel and virtual ring labels that are added to traffic to be transmitted over a virtual RPR subring of the physical RPR ring according to the present invention. This multicast information includes a tunnel label 410 and a virtual ring label 420. The tunnel label may be twenty bits in length, with four bits 415 indicating that the traffic is multicast traffic. The remaining bits are reserved. The virtual ring label 420 may be twenty bits in length, with five bits 425 indicating the virtual ring identifier (VRID), and twelve bits 430 indicating an optional virtual local area network identifier (S-VID). The remaining bits are reserved. Generally, the VRID is the same as the virtual switch identifiers (VSIDs) of the virtual switches that share the virtual RPR subring, allowing the automatic creation of virtual RPR subrings when assigning a physical RPR port to a virtual switch; however, a different VRID may be assigned to support the interconnection of virtual RPR subrings with different physical RPR rings.

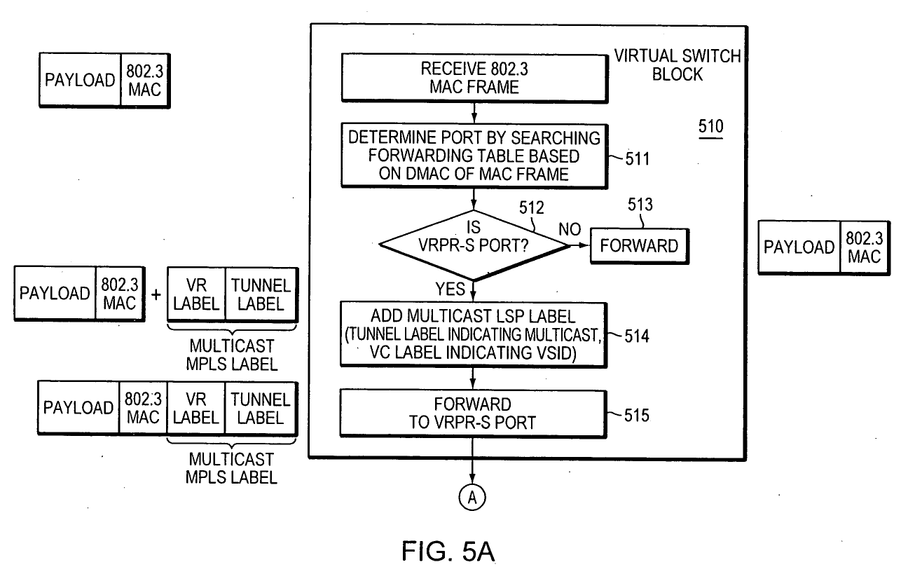

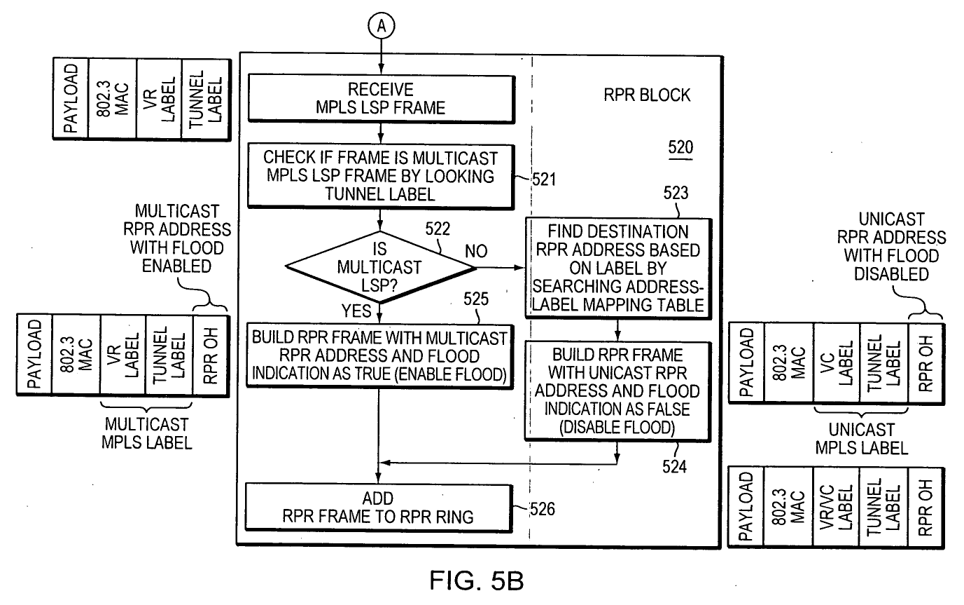

FIGS. 5A and 5B are flow diagrams that illustrate adding the above information to traffic at a virtual switch in order to transmit the traffic over the virtual RPR subrings according to an embodiment of the present invention. A virtual switch 510 receives traffic from an associated physical port and determines to what port to forward the traffic by searching a forwarding table based on a destination MAC address (511). The virtual switch 510 then determines whether the port to which the traffic is to be forwarded is a virtual RPR subring port (512). If not, the traffic is forwarded to the determined port without modification (513); however, if the determined port is a virtual subring port, then a tunnel label indicating multicast traffic and a virtual ring label indicating the virtual switch identifier is added to the traffic (514).

The modified traffic is then sent to the RPR block 520 (515). The RPR block 520 determines whether the traffic is multicast traffic by examining the tunnel label (521). If the traffic is not multicast, then a destination RPR address is determined by searching an address label mapping table (523). The traffic is then encapsulated with an RPR frame having a unicast RPR address and flooding disabled (524) and added to the RPR ring (526). If the traffic is multicast, then the traffic is encapsulated with an RPR frame having a multicast RPR address and flooding enabled (525) and added to the RPR ring (526).

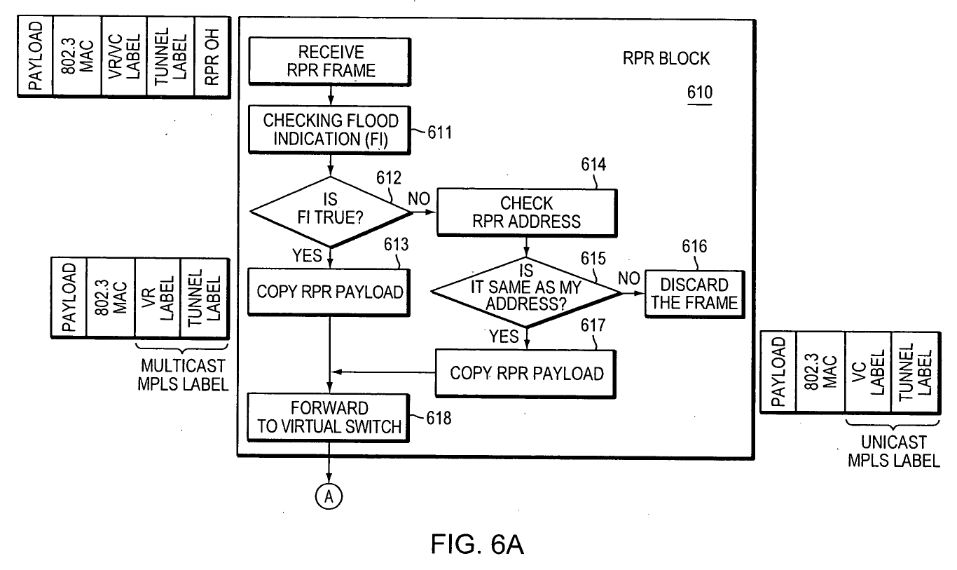

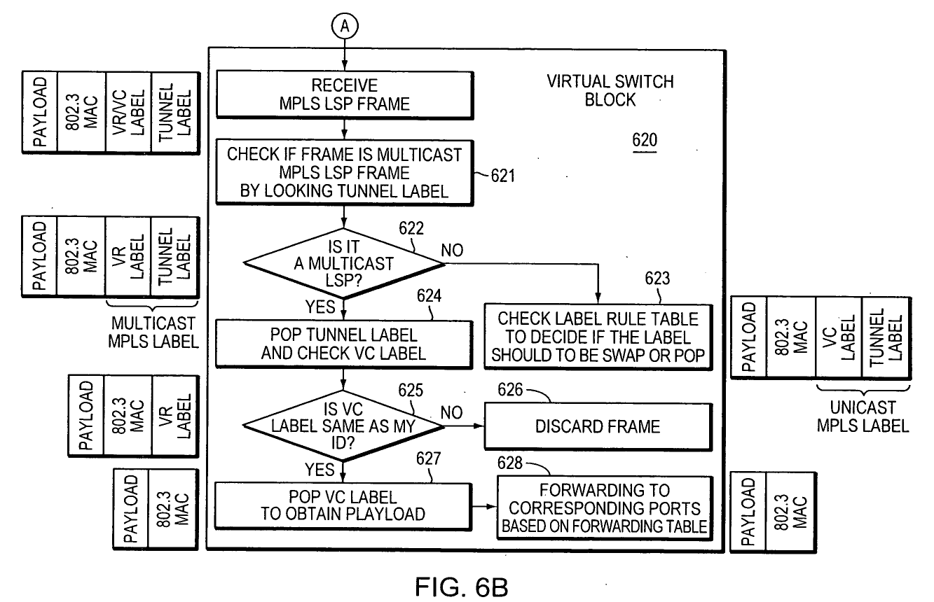

FIGS. 6A and 6B are flow diagrams that illustrate handling network traffic received at a virtual switch from the virtual RPR subrings according to the present method and apparatus. Upon receiving an RPR frame, the RPR block 610 determines whether flooding has been enabled for the traffic (611 and 612). If it has been enabled, then the RPR payload is copied (613) and forwarded to the virtual switch 620 (618); however, if flooding has not been indicated, then the RPR block 610 determines whether the destination MAC address in the overhead of the RPR frame is the same as its own MAC address (614 and 615). If it is not the same, then the frame is discarded (616); however, if the addresses match, then the RPR payload is copied (617) and forwarded to the virtual switch 620 (618).

The virtual switch 620 determines whether the frame is multicast traffic by examining the tunnel label (621 and 622). If the frame is not multicast traffic, the virtual switch takes further action according to a label rule table (623); however, if the frame is multicast traffic, then the tunnel label is removed (624). The virtual switch 620 then determines whether the virtual ring label is the same as the virtual switch identifier (625). If it is not the same, then the frame is discarded (626); however, if the virtual ring label and the identifier of the virtual switch match, then the virtual ring label is removed from the frame (627), and the underlying payload is forwarded to a port based on a forwarding table (628).

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 5A, 5B, 6A, and 6B are examples that can include more or fewer components, be partitioned into subunits, or be implemented in different combinations. Moreover, the flow diagrams may be implemented in hardware, firmware, or software. If implemented in software, the software may be written in any software language suitable for use in networks as illustrated in FIGS. 1-3 with traffic having overhead information as illustrated in FIG. 4. The software may be embodied on any form of computer readable medium, such as RAM, ROM, or magnetic or optical disk, and loaded and executed by generic or custom processor(s).

The invention is applicable to any network topology as long as a ring network, such as a Synchronous Optical Network (SONET) ring network, is established. Further, the ring network example may use various Layer 1 protocols, such as Unidirectional Path Switched Ring (UPSR) or Bidirectional Line Switched Ring (BLSR) protocols.

What is claimed is:

1. A ring network, comprising:
multiple physical switches configured with multiple virtual switches on a ring network; and
modules in the multiple virtual switches to add multicast information to traffic to direct the traffic along a common path to at least one other physical switch on the ring network.

2. The network of claim 1 further comprising at least one module in the multiple virtual switches to inspect multicast information in traffic received from the common path from other virtual switches to direct the traffic to a destination associated with at least one of the multiple virtual switches.

3. The network of claim 1 wherein the multicast information includes a virtual ring label and a multicast tunnel label.

4. The network of claim 3 wherein the virtual ring label includes virtual switch information.

5. The network of claim 4 wherein each of the multiple virtual switches includes a virtual switch identifier and the virtual switch information corresponds to a virtual switch identifier of at least two virtual switches in different physical switches on the ring.

6. The network of claim 3 wherein the virtual ring label includes information to direct the traffic to another ring network.

7. The network of claim 1 wherein the multicast information includes information to flood the traffic to the multiple physical switches on the ring.

8. The network of claim 1 further including multiple interconnected rings.

9. The network of claim 1 wherein the common path includes a plurality of subpaths, the total bandwidth of all the subpaths not exceeding the bandwidth of the path.

10. A method for providing a ring network, the method comprising:
adding multicast information to traffic to be communicated between virtual switches in different physical switches on a ring network; and
forwarding the traffic to a path between the different physical switches on the ring network carrying other traffic between other virtual switches in the different physical switches.

11. The method of claim 10 wherein adding multicast information includes adding virtual switch information corresponding to a virtual switch identifier shared by at least two of the virtual switches in the different physical switches.

12. The method of claim 10 wherein adding multicast information includes adding information corresponding to another network to support virtual interconnection with the other network.

13. The method of claim 10 wherein adding multicast information includes adding a virtual ring label and a multicast tunnel label to the traffic.

14. The method of claim 10 wherein adding multicast information includes adding information to the traffic to flood the traffic to the physical switches on the ring.

15. The method of claim 10 wherein forwarding the traffic to a path between the different physical switches on the ring network includes forwarding the traffic to a path on the ring network carrying traffic from all virtual switches on the ring network.

16. The method of claim 10 wherein forwarding the traffic to a path includes forwarding the traffic to at least one of a plurality of subpaths, the total bandwidth of the subpaths not exceeding the bandwidth of the path.

17. A computer readable medium having computer readable program codes embodied therein for providing a packet ring network, the computer readable medium program codes including instructions that, when executed by a processor, cause the processor to:
add multicast information to traffic to be communicated between virtual switches in different physical switches on a ring network; and
forward the traffic to a path between the different physical switches on the ring network carrying other traffic between other virtual switches in the different physical switches.

18. A physical switch, comprising:
multiple virtual switches; and
at least one module to add multicast information to traffic to cause at least two of the multiple virtual switches to direct the traffic to a common path to at least one other physical switch.

19. The physical switch of claim 18 wherein the multicast information includes a virtual ring label and a multicast tunnel label.

20. The physical switch of claim 19 wherein the virtual ring label includes virtual switch information.

21. The physical switch of claim 20 wherein each of the multiple virtual switches includes a virtual switch identifier and the virtual switch information corresponds to a virtual switch identifier of at least one of the multiple virtual switches.

22. The physical switch of claim 18 wherein the common path includes a plurality of subpaths, the total bandwidth of all the subpaths not exceeding the bandwidth of the path.

23. A method for providing multiple virtual switches in a physical switch, the method comprising:
adding multicast information to traffic originating from at least one virtual switch of the physical switch; and
forwarding the traffic to a common path carrying other traffic from at least one other virtual switch of the physical switch.

24. The method of claim 23 wherein adding multicast information includes adding virtual switch information corresponding to a virtual switch identifier of the at least one virtual switch of the physical switch.

25. The method of claim 23 wherein adding multicast information includes adding a virtual ring label and a multicast tunnel label.

26. The method of claim 23 wherein adding multicast information includes adding information to flood the traffic to physical switches on a ring network.

27. The method of claim 23 wherein forwarding the traffic to a common path includes forwarding the traffic to a common path carrying traffic from the multiple virtual switches of the physical switch.

28. The method of claim 23 wherein forwarding the traffic to a path includes forwarding the traffic to at least one of a plurality of subpaths, the total bandwidth of the subpaths not exceeding the bandwidth of the path.

29. A computer readable medium having computer readable program codes embodied therein for providing multiple virtual switches in a physical switch, the computer readable medium program codes including instructions that, when executed by a processor, cause the processor to:
add multicast information to traffic originating from at least one virtual switch of the physical switch; and
forward the traffic to a common path carrying other traffic from at least one other virtual switch of the physical switch.

30. A physical switch, comprising:
multiple virtual switches; and
at least one module to inspect multicast information in traffic received from a path from other virtual switches in another physical switch to direct the traffic to a destination associated with at least one of the multiple virtual switches.

31. The physical switch of claim 30 wherein the multicast information includes a virtual ring label and a multicast tunnel label.

32. The physical switch of claim 31 wherein the virtual ring label includes virtual switch information.

33. The physical switch of claim 32 wherein each of the multiple virtual switches includes a virtual switch identifier and the virtual switch information corresponds to a virtual switch identifier of at least one of the multiple virtual switches.

34. The physical switch of claim 33 wherein each of the other virtual switches includes a virtual switch identifier and the virtual switch information corresponds to a virtual switch identifier of at least one of the other virtual switches.

35. A method for providing multiple virtual switches in a physical switch, comprising:
providing traffic to multiple virtual switches in a physical switch; and
forwarding the traffic to a destination associated with at least one of the virtual switches if the traffic includes virtual switch information corresponding to a virtual switch identifier of the at least one virtual switch.

36. The method of claim 35 wherein providing traffic to the multiple virtual switches includes providing traffic to the multiple virtual switches if the multicast information includes flooding information.

37. The method of claim 35 wherein the multicast information includes a multicast tunnel label and a virtual ring label.

38. The method of claim 35 wherein forwarding the traffic to a destination includes removing the traffic's multicast information.

39. A computer readable medium having computer readable program codes embodied therein for providing multiple virtual switches in a physical switch, the computer readable medium program codes including instructions that, when executed by a processor, cause the processor to:
provide traffic to multiple virtual switches in a physical switch based on a state of multicast information in an overhead of the traffic being in an active state; and
forward the traffic to a destination associated with at least one of the virtual switches if the traffic includes virtual switch information in the overhead corresponding to a virtual switch identifier of the at least one virtual switch.

40. A traffic signal embodied in a carrier wave for supporting communications in a ring network, the traffic signal comprising:
overhead bits with multicast information and at least one bit defining the traffic to be flooded traffic.

41. The traffic signal of claim 40 wherein the multicast information includes a virtual ring label and a multicast tunnel label.

42. The traffic signal of claim 40 wherein the at least one bit is within a multicast resilient protection ring (RPR) overhead.
